(19) United States
(12) Patent Application Publication
(10) Pub. No.: US 2006/0200842 A1
(43) Pub. Date: Sep. 7, 2006

(54) Picture-in-picture (PIP) alerts

(75) Inventors: Ann E. Chapman, Santa Cruz, CA (US); Pradhan S. Rao, Sunnyvale, CA (US); Olga Komsitsky, San Ramon, CA (US); Samuel Thomas Scott III, Los Gatos, CA (US); Smita Hashim, Saratoga, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/069,627

(22) Filed: Mar. 1, 2005

(51) Int. Cl. H04N 7/025

(52) U.S. Cl. 725/34

(57) ABSTRACT

Strategies are described for detecting events that match pre-established criteria based on a consumer profile, formulating picture-in-picture (PIP) alerts based on the matching events, and providing the PIP alerts to the consumer's output device. The output device can present plural PIP alerts, either by presenting multiple PIP alerts at the same time, or by sequencing through the multiple PIP alerts within a single PIP pane. The consumer can navigate among the PIP alerts to activate a desired PIP alert, prompting the presentation of supplemental information regarding the PIP alert, such as a video stream associated with the PIP alert or additional textual information associated with the PIP alert.

### TECHNICAL FIELD

This subject matter relates to strategies for presenting alerts. In a more particular implementation, this subject matter pertains to strategies for presenting alerts in the context of an environment which disseminates media information to consumers.

### BACKGROUND

Providers of media distribution systems can use their services to transmit alerts to their respective consumers. For instance, in the United States, the well-known Emergency Alert System (EAS) (previously referred to as the Emergency Broadcast System) provides a mechanism by which participating television and radio broadcast systems can transmit messages to consumers. Most commonly, these alerts inform the consumers of dangerous situations (such as an impending storm). More recently, these types of alerts have been successfully used to inform the public of the abduction of children in hopes of soliciting information from the public regarding the whereabouts of the children. In the context of a traditional television broadcast system, alert messages can be scrolled across a portion of the television screen in a slow-moving text message. Traditionally, consumers cannot control the conditions under which EAS-type alerts are sent. Nor can the consumers interact with these EAS-type alerts once they appear.

In the commercial domain, providers of media information have also attempted to integrate alert prompts into the presentation of media information. For instance, while the EAS program is sponsored by the U.S. government, many commercial providers have independently adopted the scrolling marquee-type presentation to alert consumers to a variety of events that may be of interest to the consumers.

One system that provides a more versatile commercial alert system is disclosed in the commonly assigned U.S. application Ser. No. 10/052,111 (the '111 application), filed on Jan. 17, 2002 by Joseph A. Schrader et al., entitled “EHNANCED TELEVISION SERVICES FOR DIGITAL VIDEO RECORDING AND PLAYBACK.” This disclosure describes a mechanism for transmitting tunable alert information to client media devices. Upon receipt, the consumers can then select the tunable alert. The alert mechanism disclosed in the '111 application is particularly well suited for alerting users to events that occur in a sports-related broadcast.

There is room for improvement in the above-described systems. As appreciated by the present inventors, it is desirable to provide alert information having richer content than heretofore provided, in conjunction with more versatile and automated mechanisms for presenting the alert information to consumers and allowing the consumers to navigate within an alert information presentation. As appreciated by the present inventors, it is also desirable to provide more versatile and useful mechanisms for defining events that will prompt the generation of alert information.

For at least the above-identified reasons, there is an exemplary need for more satisfactory alert mechanisms for use in conjunction with media distribution systems.

### SUMMARY

Strategies are described herein which address the needs set forth above, as well as other needs. More specifically, the exemplary strategies meet the fourfold aim of: (1) culling alerts in a more intelligent manner than heretofore provided by known systems; (2) formulating more informative alerts than heretofore provided; (3) presenting these alerts in a more compelling and automatic manner than heretofore provided; and (4) ensuring that the improved alert experience provided by the first three features does not have the negative consequence of becoming unduly distracting to the consumer.

According to one exemplary implementation, a method is described for presenting alerts to a consumer of media information. The method comprises: detecting an event from at least one source of events that meets at least one pre-established criterion defined by the consumer, to define a matching event; in response to the detecting, automatically formulating the matching event into a picture-in-picture (PIP) alert having a pictorial component; and providing the PIP alert to an output device associated with the consumer, where the PIP alert is automatically presented by the output device.

According to another exemplary feature, the detecting comprises accessing a profile associated with the consumer to provide the above-mentioned at least one criterion.

According to another exemplary feature, the output device is configured to present multiple PIP alerts at the same time.

According to another exemplary feature, the output device sequences through multiple PIP alerts within a single PIP alert pane.

According to another exemplary feature, the method further comprises navigating, by the consumer, among the plural PIP alerts to select a desired PIP alert.

Additional exemplary implementations are described in the following.

### BRIEF DESCRIPTION OF THE DRAWINGS

FIG. 1 shows an exemplary system that provides an improved alert experience through the presentation of one or more PIP alerts.

FIG. 2 shows exemplary event processing functionality for use in the system of FIG. 1.

FIG. 3 shows exemplary details of client-side processing of the PIP alerts produced by the event processing functionality of FIG. 2.

FIG. 4 shows an exemplary user interface mechanism that allows a consumer to establish a profile, used to govern the operation of the event processing functionality of FIG. 2.

FIGS. 5-8 show exemplary user interface presentations that demonstrate different ways of presenting the PIP alerts to the consumer.

FIG. 9 shows an exemplary procedure for providing PIP alerts to the consumer using the system of FIG. 1.

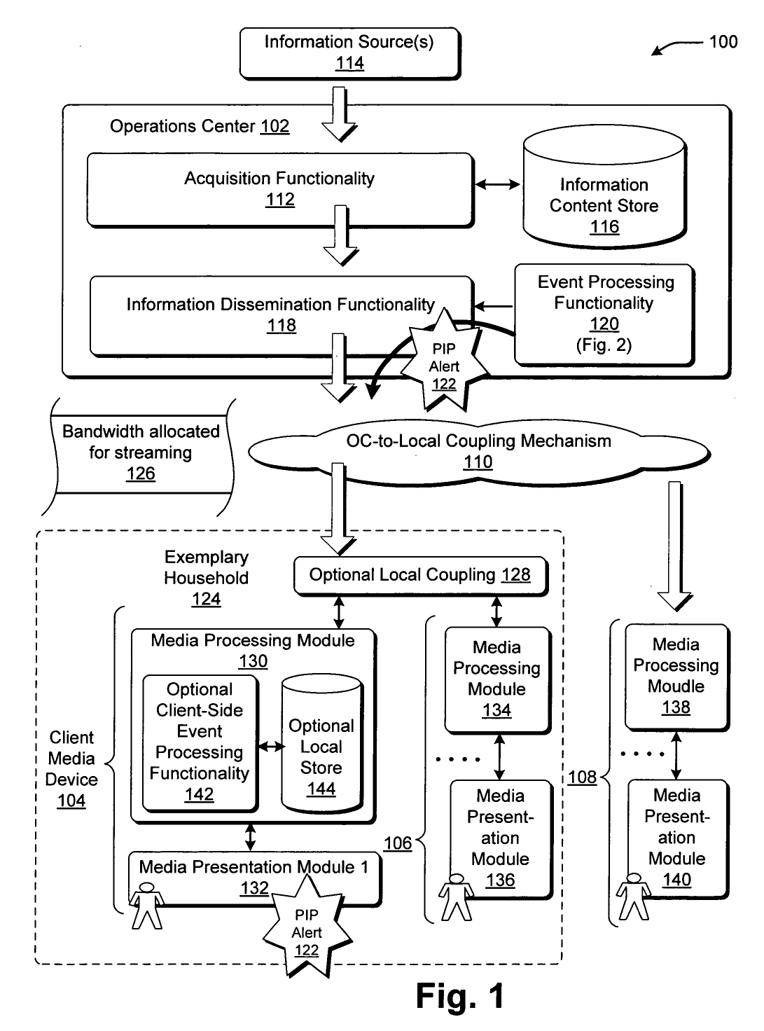

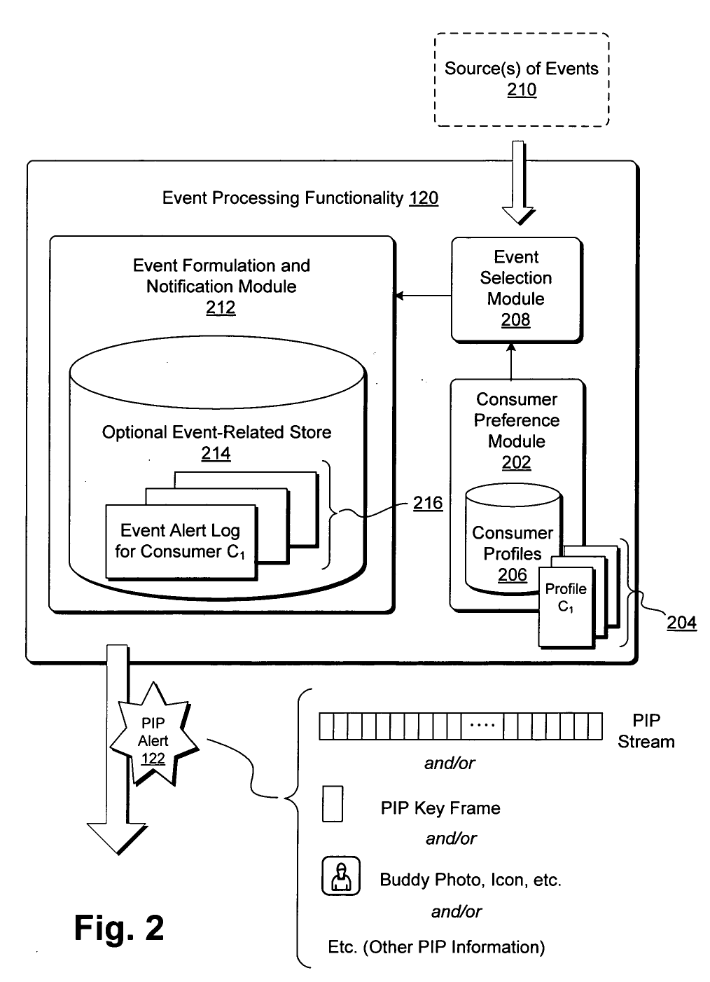

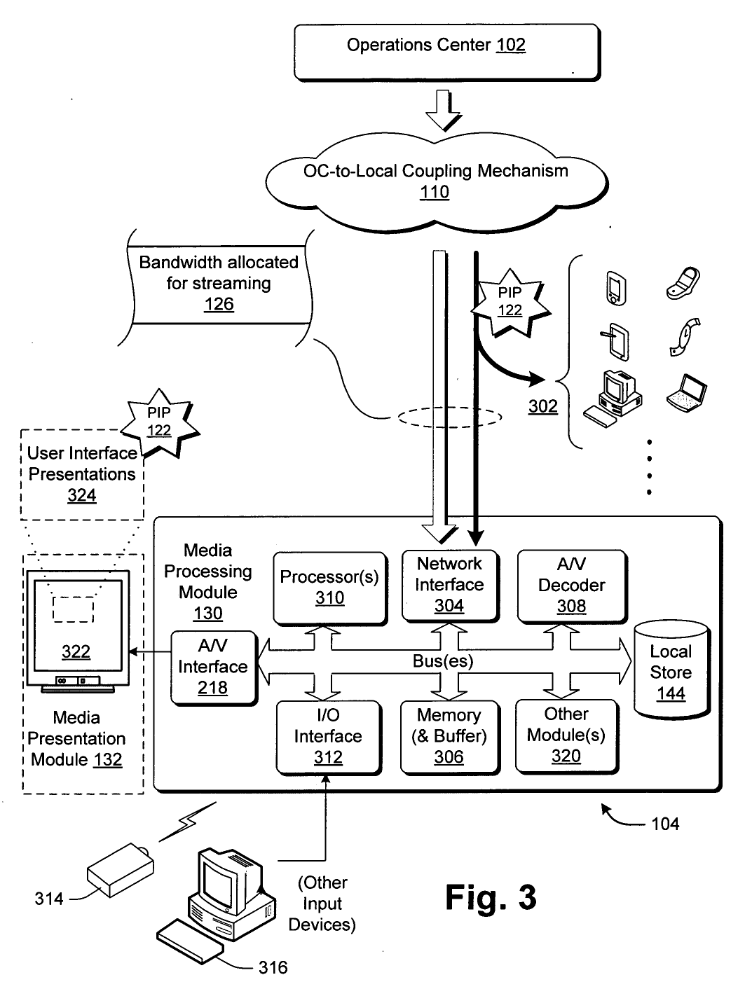

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

The following description sets forth strategies for detecting events that match pre-established criteria based on a consumer profile, automatically formulating picture-in-picture (PIP) alerts based on the matching events, and providing the PIP alerts to the consumer's output device. The output device can retain and present plural PIP alerts, either by presenting multiple PIP alerts at the same time, or by sequencing through the multiple PIP alerts within a single PIP pane. The consumer can navigate among the retained plural PIP alerts to activate a desired PIP alert, prompting the presentation of supplemental information regarding the PIP alert, such as a video stream associated with the PIP alert or supplemental textual information associated with the PIP alert.

The strategies described herein confer a number of benefits. According to one benefit, the use of a consumer profile to generate an alert provides an alert experience that is more finely tuned to the needs of the individual consumer (compared to the generation of alerts based on fixed parameters which apply to all consumers). According to another benefit, the use of PIP alerts having a pictorial component provides a much richer alert experience (compared to the generation of textual alert messages). According to another benefit, the display of multiple retained PIP alerts, coupling with the use of mechanisms that allow the consumer to navigate among the retained PIP alerts, provide a well-managed alert experience to the consumer, reducing the potential that the alerts will undesirably distract the consumer from his or her viewing of a main media presentation (upon which the PIP alerts are overlaid). According to another benefit, the PIP alerts can be automatically presented to the consumer upon the occurrence of matching events, eliminating or reducing the burdensome amount of interaction that the consumer would otherwise have to perform to receive this content.

Additional features and attendant benefits of the strategies will be set forth in this description.

As to terminology, the term “media information” refers to any data represented in electronic form that can be consumed by a user. The media information can include any information that conveys audio and/or video information, such as audio resources (e.g., music, spoken word subject matter, etc.), still picture resources (e.g., digital photographs, etc.), moving picture resources (e.g., audio-visual television programs, movies, etc.), computer programs (e.g., games, etc.), and so on. The media information may include, or may omit, interactive content. The media information can be delivered according to a fixed schedule, or on an On-Demand basis (e.g., VOD delivery). The media information can be delivered free of charge, or using any kind of fee-based business model.

The term “output device” refers to any unit for processing and presenting media information. For example, the output device can comprise a “client media device,” which, in turn, can comprise a television set, a digital video recorder (DVR), a rewritable digital video disc (DVD-RW) device, a computer equipped with media processing functionality, and so forth, or some combination of such devices. The output device can also comprise devices which traditionally are not considered media presentation devices, such as mobile telephones, wearable computer devices (e.g., computer-equipped watches), personal digital assistant devices (PDAs), and so forth. As will be described, PIP alerts can be presented together with a main media presentation on a single output device, such as by overlaying the PIP alerts on top of the main media presentation. Or the PIP alerts can be presented in any unused portion of the media presentation display, such as, but not limited to, a “letterbox” area of the screen that is traditionally used to present only text information (e.g., the PIP alerts can be presented in the black border areas of such a letterbox region); this implementation allows the PIP alerts to be displayed without obscuring any of the primary video content. Or the PIP alerts can be presented on a first output device, while the main media presentation can be presented on an entirely separate output device.

The term “consumer-allocated data bandwidth” (or simply “bandwidth” for brevity below) refers to a maximum bit rate that can be used to transmit media information to the output device from a source of such information. For instance, an operations center may allocate a prescribed amount of bandwidth to a household for its use in receiving the media information (where the bandwidth may ultimately reflect the respective capacities of the equipment used to implement the communication channel that couples the operations center to the household). In addition, or alternatively, the operations center could potentially throttle the available bandwidth based on business considerations (rather than the physical limitations of the communication channel). In any event, the term bandwidth refers to the bit rate available to the output devices in the household, rather than the amount of “back end” bandwidth available to the operations center itself to implement its services. Moreover, the term bandwidth does not refer in the traditional sense to an allotted frequency band used to transmit analog signals bearing media information.

This disclosure includes the following sections. Section A explains an exemplary system for presenting enhanced alerts. Section B presents various exemplary user interface presentations that can be used to display the enhanced alerts to consumers. And Section C presents a flowchart that describes one exemplary manner of operation of the system of Section A.

A. Exemplary System (FIGS. 1-3)

Generally, any of the functions described with reference to the figures can be implemented using software, firmware (e.g., fixed logic circuitry), manual processing, or a combination of these implementations. The term “logic, “module” or “functionality” as used herein generally represents software, firmware, or a combination of software and firmware. For instance, in the case of a software implementation, the term “logic,” “module,” or “functionality” represents program code (and/or declarative-type instructions) that performs specified tasks when executed on a processing device or devices (e.g., CPU or CPUs). The program code can be stored in one or more computer readable memory devices. More generally, the illustrated separation of logic, modules and functionality into distinct units may reflect an actual physical grouping and allocation of such software and/or hardware, or can correspond to a conceptual allocation of different tasks performed by a single software program and/or hardware unit. The illustrated logic, modules and functionality can be located at a single site (e.g., as implemented by a processing device), or can be distributed over plural locations.

A.1. Overview of the System (FIG. 1)

FIG. 1 shows one exemplary system 100 among many possible systems that can be used to create, propagate and consume PIP alerts. By way of overview, the system 100 includes an operations center 102 for delivering streams of media information to a collection of client media devices (104, 106, . . . 108) via a coupling mechanism 110. In the exemplary design strategy shown in FIG. 1, the operations center 102 implements the majority (or all) of the logic used to provide the PIP alerts. This allows for the use of relatively “lightweight” client media devices (104, 106, . . . 108), which can be marketed and maintained in an efficient manner. However, other solutions are possible. In another design, the logic used to provide the PIP alerts can be shared between the operations center 102 and the client media devices (104, 106 . . . 108). In another design, the client media devices (104, 106, . . . 108) can be used to implement the majority (or all) of the logic used to provide the PIP alerts.

In the illustrated head-end-centric design approach, the operations center 102 includes acquisition functionality 112 for supplying the media information from one or more sources 114 of such information. The sources 114 can represent any kind of entity which produces or provides media information, such as cable or satellite television providers, one or more Video-On-Demand (VOD) providers, one or more publishing houses of information, one or more library sources, any kind of Internet-enabled repository, and so on. The media information received from these sources 114 can include video, audio, still pictures, and/or other multimedia content. In general, the sources 114 can supply live information or prerecorded information. Live information corresponds to information that captures a current state of an ongoing event (such as a sporting event which is being televised live). Prerecorded information corresponds to information that has already been recorded in its entirety. The acquisition functionality 112 itself can comprise one or more server computers or other functionality dedicated to the task of retrieving the resource information.

The operations center 102 optionally includes an information content store 116 for storing the media information prior to its dissemination to the client media devices (104, 106, . . . 108). The information content store 116 can be implemented as one or more databases and associated database management functionality.

The coupling mechanism 110 couples the operations center (OC) 102 to the client media devices (104, 106, . . . 108), and is therefore referred to as an OC-to-local coupling mechanism. This coupling mechanism 110 can be implemented in different ways to suit different technical and commercial environments. For instance, the coupling mechanism 110 can include any kind of network (or combination of networks), such as a wide area network (e.g., the Internet), an intranet, Digital Subscriber Line (DSL) network infrastructure, point-to-point coupling infrastructure, and so on. The coupling mechanism 110 can use or involve any kind of protocol or combination of protocols. In the case where one or more digital networks are used to disseminate information, the coupling mechanism 110 can include various hardwired and/or wireless links, routers, gateways, name servers, and so on. In the case where DSL infrastructure is used to disseminate information, the coupling mechanism 110 can utilize the services, in part, of telephone coupling infrastructure and DSL processing functionality.

The system operations center 102 also optionally includes information dissemination functionality 118 for supplying media information and PIP alerts to the client devices (104, 106, . . . 108) via the coupling mechanism 110. Different systems may use the information dissemination functionality 118 in different ways. One exemplary system may use the information dissemination functionality 118 to transmit media information received from the acquisition functionality 112 or from some other source (e.g., from a VOD source) in unicast fashion. Another exemplary system may use the information dissemination functionality 118 to transmit media information in broadcast or multicast fashion (using, for example, the Internet Group Management Protocol (IGMP)). In the unicast technique, the media information is delivered to client media devices (104, 106, . . . 108) in one-to-one fashion. That is, a recipient client media device (104, 106, . . . 108) can receive a unicast stream of media information by establishing a one-to-one coupling with the source of such media information. In the IGMP multicast technique, the media information is broadcast to a group of recipients by a tree of distribution nodes which receive the resource information from an ultimate source. A recipient client media device (104, 106, . . . 108) can join the ongoing multicast by tapping into the multicast distribution; it can perform this task by locating an appropriate distribution node within the tree of such nodes.

In another implementation, the information dissemination functionality 118 can deliver media information using a combination of unicast communication and multicast communication. For example, a client media device (104, 106, . . . 108) can receive media information in a burst when the consumer first “tunes” to the media information. The burst exceeds nominal steady state data rates. After receiving the initial burst of unicast media information, the client media devices (104, 106, . . . 108) can switch over to receiving the same stream of media information via a multicast delivery technique. Co-pending and commonly assigned U.S. patent application Ser. No. 10/010,200, entitled, “ACCELERATED CHANNEL CHANGE IN RATE-LIMITED ENVIRONMENTS,” naming the inventors of Geoffrey R. Smith et al., filed on Dec. 10, 2004, provides further exemplary details regarding one protocol for delivering resource information using a combination of unicast and multicast techniques. This patent application is incorporated by reference herein in its entirety. This accelerated burst technology is beneficial to allow the buffers (not shown) maintained by the client media devices (104, 106, . . . 108) to more quickly fill up upon a channel change, which thereby reduces the delay required to present media information upon switching to a new channel (or, more generally, starting a video stream in any manner).

Another potential role performed by the information dissemination functionality 118 is to receive retry requests from the client media devices (104, 106, . . . 108) and send retry packets to the client media devices (104, 106, . . . 108) in response to these requests. Co-pending and commonly assigned U.S. patent application Ser. No. 11/012,891, entitled, “RETRY STRATEGIES FOR USE IN A STREAMING ENVIRONMENT,” naming the inventors of Dustin L. Green et al., filed on Dec. 15, 2004, provides further exemplary details regarding one exemplary protocol for performing retry operations in a media distribution system. This patent application is incorporated by reference herein in its entirety.

The information dissemination functionality 118 can be implemented as a collection of server modules (not shown) that facilitate the transmission of media information to the client media devices (104, 106, . . . 108). The server modules may provide redundant services, such that any of the server modules can be assigned to provide the same service to any of the client media devices (104, 106, . . . 108).

Whatever delivery strategy is used, the operations center 102 can deliver media information to the client media devices (104, 106, . . . 108) using a variety of packaging paradigms. In one case, the operations center 102 can supply a sequence of programs to users in different channels. In this mode, the operations center 102 can present the programs according to a fixed schedule, in the manner of traditional delivery of channels (although the channels do not have the frequency-specific connotation of traditional analog systems which use physical tuners). In another case, the operations center 102 can supply individual programs to users at fixed times. In a VOD-related case, the operations center 102 can deliver individual media programs to a user whenever the user requests the programs. Still other program packaging paradigms are possible.

The media information itself can be expressed in any format, including, but not limited to, the MPEG-2 standard, Microsoft Corporation's VC-1 standard, the ISO/ITU H.264 standard, and so forth. The coded media information can be encapsulated into packets using any format, including, but not limited to, the Real Time Transport Protocol (RTP), the Real Time Streaming Protocol (RTSP), the Advanced Streaming Format (ASF), and so forth. The above-described above-nominal burst of media information is preferably configured to start at a key frame (e.g., in the MPEG-2 standard, an I frame, rather than a B or P frame). This better ensures that the client media devices (104, 106, . . . 108) can quickly begin presenting the media information in an unproblematic manner (because, otherwise, these devices would need to wait for the occurrence of a key frame in the stream of media information).

Finally, the operations center 102 also includes event processing functionality 120. The purpose of the event processing functionality 120 is to: (a) examine one or more sources of event information to determine whether a reportable event has occurred (with reference to a consumer-specific profile for each consumer); (b) formulate matching event information into a PIP alert (symbolically represented in FIG. 1 as the star-shaped PIP alert 122); and c) use the resources of the information dissemination functionality 118 to deliver the PIP alert 122 to one or more client media devices (104, 106, . . . 108). The information dissemination functionality 118 can combine the PIP alert 122 with a main stream of media information (which corresponds to a program that the consumer is currently watching as a main focus of interest in full-scale mode). Subsection A.2 (below) provides detailed information regarding the operation of the event processing functionality 120. As mentioned above, FIG. 1 is based on a head-end-centric implementation of the event processing functionality 120, but other implementations are possible which can implement the event processing functionality 120 by a distribution of logic in the operations center 102 and the client media devices (104, 106, . . . 108), or, in another case, mostly in the client media devices (104, 106, . . . 108).

Now referring to the client-side aspects of the system 100, a communication channel couples the operations 102 to each particular client media device (104, 106, . . . 108) (or to a grouping of such client media devices). The operations center 102 allocates a prescribed bandwidth to each communication channel. In one exemplary implementation, the operations center 102 delivers the media information at a constant bit rate. In another exemplary implementation, the operations center 102 delivers the media information at a variable bit rate that is capped by a prescribed maximum bit rate. In any case, the bandwidth is preferably made large enough to accommodate the presentation of a main stream of AV information in combination with one or more supplemental PIP alerts 122. The precise bandwidth that is required can depend on various factors, such as the projected maximum number of streams that need to be delivered at the same time, the respective resolutions associated with those streams, whether the PIP alerts 122 pertain to static or dynamic content, and so forth. In one entirely exemplary and non-limiting environment, the system 100 can provision enough bandwidth to accommodate several concurrent streams and other media content. The operations center 102 can also potentially vary the amount of allocated bandwidth supplied to a client media device (104, 106, . . . 108) based on marketing considerations, such as whether or not the consumers subscribe to a premium service that accommodates the presentation of additional concurrent streams. (However, note that, because the present design dispenses with the use of physical tuners, the design does not impose any limitations on the number of “virtual tuners” that can be employed to simultaneously receive streams of media information.)

Consider, for example, a case in which an exemplary household 124 includes plural client media devices (104, . . . 106) that “feed off” an allocated amount of bandwidth 126. In this case, the client media devices (104, . . . 106) can carve up the maximum bandwidth 126 in various manners to present concurrent streams on the client media devices (104, . . . 106) within the household. An individual client media device (104, . . . 106) that tunes to receive multiple concurrent streams can present these streams in different respective panes of its display surface. For instance, the client media device (104, . . . 106) can present a principal video stream over substantially the entire display surface. The client media device (104, . . . 106) can present one or more PIP alert-related streams (or thumbnails) in one or more smaller PIP panes which are “overlaid” on top of the main display section associated with the principal video stream, obscuring the main presentation which “lies beneath” the PIP panes. Or the PIP alerts 122 can be displayed in an unused portion of the display, such as a letterbox region of the display.

An optional local coupling mechanism 128 can be used to couple the client media devices (104, . . . 106) together within the household. For example, in one exemplary arrangement, one of the client media devices (104, . . . 106) can act as a host by receiving the media information from the operations center 102 via the OC-to-local coupling mechanism 110, and then route streams contained therein to appropriate recipient client media devices (104, 106, . . . 108) within the household that have “tuned” to receive these streams. The local coupling mechanism 128 can be implemented as a local network (e.g., an Ethernet network), and or other coupling strategy.

The client media devices (104, 106, . . . 108) themselves can be implemented in different ways. A given client media device (104, 106, . . . 108) may represent a television set with integral IP interfacing/processing functionality, a television set with an associated set-top box coupled thereto, a digital video recorder (DVR) device, a rewritable digital video disc (DVD-RW) device, a personal computer having AV decoding functionality, and so forth (as well as any combination of these devices). Or a given client media device (104, 106, . . . 108) can take the form of a personal mobile telephone, personal digital assistant (PDA), tablet-type computer device, any kind of wearable computer (e.g., a wristwatch-type computer device), and so forth. FIG. 1 shows a first scenario in which the client media devices (104, 106, . . . 108) which present a principal video stream also presents the PIP alerts 122. For instance, as mentioned, the PIP alerts 122 can be “overlaid” on top of the presentation of the principal video stream. In another scenario (e.g., as described in FIG. 3 below), a first client media device (104, 106, . . . 108) can be used to present the principal video stream, and a second output device can be used to present the PIP alerts 122.

In whatever manner the client media devices (104, 106, . . . 108) are implemented, they can comprise a media processing module that is communicatively coupled to a media presentation module. For instance, the client media device 104 includes media processing module 130 coupled to media presentation module 132, the client media device 106 includes media processing module 134 coupled to media presentation module 136, and the client media device 108 includes media processing module 138 coupled to media presentation module 140. The media processing modules (130, 134, . . . 138) may comprise functionality for processing the media information, and the media presentation modules (132, 136, . . . 140) may comprise functionality for presenting the output of the media presentation modules (130, 134, . . . 138). The media processing modules (130, 134, . . . 138) can be integrated with the media presentation modules (132, 136, . . . 140) (e.g., in the case where the media processing modules are integrated into respective IP-ready television sets), or the media processing modules (130, 134, . . . 138) can be separate from (but coupled to) the media presentation modules (132, 136, . . . 140) (e.g., in the case where the media processing modules are housed in respective set-top boxes that are coupled to television sets).

FIG. 1 shows an overview of the exemplary composition of the client device 104. This device 104 includes the media processing module 130, which, in turn, can comprise client-side event processing functionality 142. This functionality 142 performs whatever tasks are required to cooperate with the operations center 102 to receive and present PIP alerts 122. In one case, this functionality 142 can be used to facilitate the creation of a consumer profile that is used to govern the operation of the OC-side event processing functionality 120. This functionality 142 can also be used to present the PIP alerts 122 received from the operations center 102, e.g., in one or more PIP panes. (However, as stated above, one design approach is to simplify the client-side event processing functionality 142 as much as possible, so as to reduce the responsibilities of this functionality 142, which may provide a more “lightweight” and hence less expensive client media device 104).

Finally, the media processing device 130 may also include optional local storage 144. The local storage 144 can be used to store streams of media information (such as one or more principal streams), as well as PIP alerts (e.g., comprising thumbnail PIP alerts, PIP streams, and so forth). The local storage 144 can also be used to store consumer profile information, and so forth. However, again, these storage responsibilities are preferably allocated to the operations center 102 to simplify the construction of the client media device 104.

Co-pending and commonly assigned U.S. patent application Ser. No. ______ (Attorney Docket No. MS1-2378US), entitled, “TUNERLESS MEDIA PRESENTATION UNIT AND METHODS OF USE,” naming inventors David L. de Heer et al., filed on Feb. 14, 2005, provides further exemplary details regarding one exemplary implementation of a media client device. This patent application is incorporated by reference herein in its entirety.

To repeat, the system 100 shown in FIG. 1 represents just one of many streaming environments that can use the PIP alert strategies described herein.

A.2. Exemplary Operating Center Details (FIG. 2)

FIG. 2 provides additional details regarding the event processing functionality 120 introduced in the context of FIG. 1. This functionality 120 is preferably implemented by the operations center 102, but can alternatively be implemented, in whole or in part, by the individual client media devices (104, 106, . . . 108). To facilitate discussion, when reference is being made below to an exemplary one of the client media devices (104, 106, . . . 108), reference will be made to client media device 104.

The event processing functionality 120 includes a consumer preference module 202. The consumer preference module 202 facilitates the creation of consumer profiles 204 for respective consumers who operate the client media devices (104, 106, . . . 108). The consumer preference module 202 can also store the consumer profiles 204 in a consumer profile data store 206

The consumer profiles 204 govern the operation of the event processing functionality 120. The following non-exhaustive list identifies possible criteria that can be captured by a consumer profile associated with an exemplary consumer who operates client media device 104:
One set of criteria can identify sources from which reportable event information can be extracted.
Another set of criteria can identify conditions that define a reportable event.
Another set of criteria can instruct the event processing functionality 120 how to formulate the event information into PIP alerts (e.g., as static PIP images, as streaming PIP presentations, and so forth).
Another set of criteria can define the manner in which PIP alerts 122 are presented to the consumer (e.g., the manner in which the PIP alerts are arranged for presentation at the client media device 104).
Another set of criteria can define the manner in which the PIP alerts 122 behave when selected by the consumer.
Another set of criteria can define the manner in which the system 100 retains the PIP alerts 122 after presenting the alerts 122 to the consumer.
Another set of criteria can also define priority and throttling information that governs how the system 100 copes with the presentation of a large volume of PIP alerts 122, e.g., by ranking and/or excluding event information so as not to overwhelm the consumer with too much alert information.

The above-enumerated list of criteria is merely exemplary. Those skilled in the art will appreciate that the profiles 204 can specify additional consumer-defined criteria to suit different environments. In addition, the consumer preference module 202 can define various fixed criteria that, by default, apply to all consumers (and hence may not be configurable by individual consumers).

On the basis of the consumer profiles 204, an event selection module 208 extracts events from one or more sources 210 of events. The sources 210 can comprise a wide range of entities from which event information can be culled. The following non-exhaustive list identifies possible sources of event information:
One source may pertain to an entity which provides media information at scheduled times, such as a network that delivers media information on one or more allocated channels. For example, such a source may pertain to one or more news channels carrying news programming (e.g., CNN), one or more channels carrying sports programming (e.g., ESPN), one or more channels carrying family-oriented programming (e.g., the Disney Channel, Nickelodeon, etc.), and so forth.
Another source may pertain to an entity which provides media information on an on-demand basis, such as a video on-demand (VOD) supplier of video resources (e.g., movies).
Another source may pertain to any government organization (or like entity) that provides alert information having a bearing on the safety of the public. For example, this source may provide weather advisories, traffic information, terrorism alerts, crime-related alerts (e.g., pertaining to child abductions), and so forth.
Another source may pertain to network-accessible entities which provide information via web sites, such as online news sites, message boards, and so forth.
Another source may pertain to communication-related services, such as Email services (e.g., Microsoft Corporation's Hotmail service), instant messaging services (e.g., Microsoft Corporation's MSN Instant Messaging service), and so forth. More particularly, a consumer may specify that an identified friend constitutes a source, such that any messages transmitted to the consumer from this friend constitute reportable events.
Another source may comprise information supplied by a physical sensor (or collection of sensors). For instance, a source may comprise a sensor configured to detect radiation levels, sea levels, and so forth.
Another source may comprise one or more human beings, who manually enter event information into the system 100 (as will be described in greater detail below).

The above-enumerated list of event sources is merely exemplary. Those skilled in the art will appreciate that the event processing functionality 120 can be communicatively coupled to additional sources of event information.

The event selection module 208 can detect reportable events in different ways to accommodate the myriad of different sources described above. The following non-limiting list identifies possible functionality that the event selection module 208 can employ to detect reportable events:
One detection strategy can examine electronic program guide (EPG) information that identifies salient features of programming provided by identified sources, and applies matching criteria against this EPG information. For example, assume that the consumer expressed an interest in watching any movies that feature the actor Clint Eastwood. The event selection module 208 can periodically examine the EPG information for programs that specify Clint Eastwood and identify those programs as reportable events.
Another detection strategy can examine a source for keywords present in a stream of textual information provided by the source. For example, media information supplied by a network provider or a VOD provider may include closed-captioned text information as a component thereof. The event selection module 208 can examine this text information and flag reportable events when predetermined search terms (or specified Boolean combinations of search terms) are present in the stream of closed-captioned text information. Alternatively, the event selection module 208 can extract such text information from text-based reports posted by one or more website sources. Alternatively, the event detection module 208 can apply speech recognition functionality to determine the presence of predetermined keywords or key phrases in audio content (that is, in the event that an AV stream lacks closed-captioned text information).
Another detection strategy may provide image analysis to determine when predetermined features appear in video or static image information provided by a source. For example, based on telltale features, automatic image recognition can be configured to determine the presence of traffic congestion, weather anomalies, the presence of an intruder, explosions, and so forth.
Another detection strategy may rely on the source itself to define what events constitute reportable events. For example, the event selection module 208 can be configured to automatically identify all event information issued by a government organization (such as weather or terror advisories) as reportable events without applying separate filtering analysis thereto.
Another detection strategy may rely on artificial intelligence analysis to assess when a reportable event has occurred (or is about to occur). For example, artificial intelligence can be programmed to detect patterns of interest in financial market data, weather report data, and so forth. In sports-related applications, artificial intelligence can be used to analyze the course of a sporting event to determine when reportable events are about to occur. For instance, an artificial intelligence engine can use a suitably configured knowledge base to determine when interesting events are about to occur in the game of American football (such as an onside kick, etc.) based on various predictable patterns in this game.
Another detection strategy may rely on human analysis to manually determine when a reportable event has occurred or is about to occur. To name but one example, the operations center 102 may arrange for a human observer to attend a game and make independent judgments as to events that constitute alert-worthy occurrences. The observer can then forward event information to the operations center 102 that identifies the observer's assessments. For example, the observer can input event information into a laptop computer or other input device that the observer brings to the game, and this input device can be configured to transmit the event information to the operations center 102 via wireless transmission. In another example, a human analyst can observe the progress of a financial market and make manual assessments as to occurrences that constitute alert-worthy events.

The above-enumerated list of event detection strategies is merely exemplary. Those skilled in the art will appreciate that the event processing functionality 120 can use additional strategies depending on the specific environment to which the event processing functionality 120 is applied.

An event formulation and notification module 212 (referred to for brevity as simply an “event notification module”) can formulate the detected event information into the PIP alert 122. In the context of this disclosure, the PIP alert 122 preferably includes a component which conveys either static or dynamic pictorial content (e.g., as opposed to only textual content). Generally, a PIP alert is presented by the client media device 104 in a PIP pane. The PIP pane is commonly formed as an M×N rectangular display area that has smaller dimensions than the entire display surface provided by the client device 104 (although, more generally, the PIP pane can have any shape and size). Moreover, the PIP pane typically is presented so as to appear to “overlay” a main presentation, thus obscuring a portion of the main presentation (hence explaining the use of the term “picture-in-picture” to describe such a pane).

The event notification module 212 can formulate PIP alerts 122 in different ways depending on the content of such alerts 122, as well as other considerations. The following non-limiting list identifies possible ways of formulating PIP alerts 122:
One way of formulating a PIP alert is to provide a stream of AV information which can be presented in the PIP pane by the client media device 104. The PIP stream will typically require less bandwidth than a principal AV stream used to provide a main presentation. Upon activation, the PIP pane will present dynamic content provided by the PIP stream, while the client media device 104 will also continue to present dynamic content provided by the principal stream. Configuration criteria specified in the consumer's profile can determine how this PIP alert 212 behaves vis-à-vis the principal presentation, such as whether (or not) the audio being presented to the consumer switches from the primary presentation to the PIP alert upon the occurrence of the PIP alert.
Another way of formulating a PIP alert is to select a thumbnail representation of the reportable event, instead of a dynamic AV stream (as in the case above). In this scenario, the PIP pane can present a static image associated with the reportable event (with or without accompanying audio information). Those skilled in the art will appreciate that this way of formulating the PIP alert is advantageous because it consumes far less bandwidth than an AV PIP stream, but may be perceived by the consumer as less interesting than a dynamic presentation. One way of forming the static PIP alert is to extract a key frame that represents the reportable event from a sequence of frames in an AV stream. For example, in the exemplary MPEG-2 standard, the event notification module 212 can extract an I-frame to represent the reportable event.
Another way of formulating a PIP alert is to extract image information associated with website content (or like content). For instance, a news story posted to a website may have a text portion and an image portion (e.g., constituting one or more JPEG or GIF photos or graphics, and so forth). The event notification module 212 can extract the image information from this mixed content and formulate it into a PIP alert 122 that can be presented in a PIP pane.
Another way of formulating a PIP alert is to create video or static image information associated with a reportable event that does not inherently have a pictorial component associated therewith. For instance, consider the case of an Email message or an IM message transmitted to a consumer by a friend of the consumer. The event notification module 212 can create a PIP alert 122 that contains a photo of the message sender, an icon associated with the sender (which may be either static or dynamic), or a video vignette associated with the sender.

The above-enumerated list of event formulation strategies is merely exemplary. Those skilled in the art will appreciate that the event processing functionality 120 can use additional formulation strategies depending on the specific environment to which the event processing functionality 120 is applied. FIG. 2 graphically illustrates a few of the possible formulation strategies discussed above (note the bottom portion of this figure). Whatever format is used, in one exemplary implementation, the event notification module 212 acts to produce and forward the PIP alerts 122 in an automatic manner, that is, without user interaction (or with minimal user interaction). In other words, upon the occurrence of a matching event, the PIP alert 122 will automatically be displayed to the consumer (e.g., as a video stream, a static image, or some other format), without requiring the consumer to take steps to manually tune to this alert.

In any of the above event formulation cases, the event notification module 212 can package one or more PIP alerts 122 into different presentation formats depending on preference information set forth in the consumer profiles 204. Possible formats are again numerous. Exemplary strategies are enumerated in the following exemplary list:
In one format, the event notification module 212 can package plural PIP alerts 122 so that they are concurrently displayed by the receiving client media device 104 in multiple PIP panes. The multiple PIP panes can form a marquee-type display that appears anywhere on the display surface of the client media device 104, such as at the top or bottom of the display surface. The event notification module 212 can arrange the PIP alerts 122 in any logical sequence, such as the order in which the events were detected (or in order in which the events are independently assessed as having occurred). Alternatively, or in addition, the event notification module 212 can order the PIP alerts 122 according to priority criteria established by the consumer profiles 204. Finally, in those cases where there are too many PIP alerts 122 to efficiently fit on the display surface at one time, the event notification module 212 can provide a navigation mechanism which allows the consumer to advance to additional PIP alerts 122 by scrolling to the left or to the right (for horizontal-oriented marquee presentations) or up or down (for vertical-oriented marquee presentations).
In another format, the event notification module 212 can package plural PIP alerts 122 so that they are displayed in a single PIP pane. The event notification module 212 can sequence the different PIP alerts 122 in the single PIP pane by displaying each PIP alert 122 for a short period of time (e.g., five seconds), followed by the next PIP alert in the sequence, and looping around to the first PIP alert 122 after the last one in the sequence is displayed. Alternatively, or in addition, the event notification module 212 can include a navigation mechanism which allows the consumer to manually sequence through the PIP alerts 122. The event notification module 212 can order the PIP alerts in this cycling format based on the same criteria discussed above, e.g., based on chronological order associated with event detection or event occurrence, based on priority criteria, and so forth.
In any of the above formats, the event notification module 212 can additionally group PIP alerts 122 into different categories, and then present the PIP alerts 122 in the context of those categories. Exemplary categories include news-related events, sports-related events, weather-related events, message-related events (e.g., Email or IM events), and so forth. The event notification module 212 can demarcate the different categories using different techniques, such as by presenting different PIP alerts categories in distinct PIP panes (such as by presenting multiple separate marquees for different respective categories, or different cycling single-PIP panes for different respective categories). Or each PIP alert can include any kind of indicia that represents its category. Indicia can comprise a category-related symbol, text, color, PIP shape, and so forth.

The above-enumerated list of event presentation strategies is merely exemplary. Those skilled in the art will appreciate that the event processing functionality 120 can use additional presentation strategies depending on the specific environment to which the event processing functionality 120 is applied.

The event notification module 212 can also optimally record the PIP alerts 122 that it presents to the consumer in an event-related store 214. More specifically, the event-related store 214 can have different storage segments 216 for storing PIP alerts 122 associated with different consumers. PIP alerts 122 can be stored in different ways depending on a number of factors. For example, the PIP alerts 122 an be stored as AV streams, as static image information (e.g., pertaining to a key frame or buddy icon), as linking information (e.g., URL information) that establishes a connection to remote sources (e.g., web sites) associated with the PIP alerts 122, and so forth. The storage of PIP alerts 122 is advantageous, as it allows a consumer to go back at a later time and activate a PIP alert 122 that the consumer could not attend to when the alert 122 was first presented.

The event notification module 212 can use different strategies for determining when to remove PIP alerts 122 from the event-related store 214. In a first approach, the event notification module 212 can remove PIP alerts 122 only upon the express command of the consumer. In a second approach, the event notification module 212 can automatically remove the PIP alerts 122 that the consumer has activated (on the presumption that the consumer no longer needs these alerts). In a third approach, the event notification module 212 can automatically remove detected PIP alerts after a predetermined amount of time (which can be specified by the consumer in his or her consumer profile). Other strategies can also combine one or more of the above three approaches, or apply some other approach or combination of approaches.

Finally, once the PIP alerts 122 are presented, the event notification module 212 also controls the interactive behavior of the PIP alerts 122. In a first approach, the event notification module 212 is configured to provide supplemental information to the consumer when the consumer activates the PIP alert 122. Consider the case where the PIP alert 122 comprises an AV PIP stream presented in a corresponding PIP pane. Activation of this PIP alert 122 may prompt the event notification module 212 to present the PIP stream as the main (full-scale) presentation, thereby replacing any prior main presentation that was being displayed at the time of activation of the PIP stream. This feature can be implemented by switching between a reduced resolution PIP stream (associated with the PIP presentation) to a full resolution main presentation stream (associated with the main presentation), or by up-sampling the low resolution PIP stream for presentation as a main presentation stream. Activation of a PIP stream may also prompt the event notification module 212 to present additional metadata pertaining to the PIP alert 122 for review by the consumer.

Activation of a static image PIP alert 122 can prompt the event notification module 212 to present an AV stream associated with the PIP alert 122 (if it exists), either as a reduced resolution PIP-type stream (as presented in a PIP pane) or a full resolution principal stream (as presented over the entire display surface of the client media device 104). Or activation of a static image PIP alert 122 can prompt the event notification module 212 to present additional textual metadata in the manner described above.

After the PIP alert 122 has been invoked and the content associated therewith has been presented, the event notification module 212 can be configured to return the display state of the client media device 104 to its original state prior to the occurrence of the PIP alert 122. This may constitute again displaying whatever main (full resolution) stream was being presented when the PIP alert 122 occurred. More specifically, the event notification module 212 can return to a program that was interrupted by a PIP alert 122 by resuming that program from the precise point that the PIP alert 122 occurred (which can be implemented by recording the point in the program at which the PIP occurred and storing the content that the consumer may have missed due to the PIP alert 122). Or the event notification module 212 can assume that the program has continued to run, and resume presentation at a current (real time) point in that ongoing program.

The above-described functionality provided by the event processing functionality 120 can be implemented in various ways. For example, in the embodiment in which the event processing functionality 120 is implemented by the operations center 102, the event processing functionality 120 can be implemented by one or more server machines in cooperation with one or more databases (and associated database management functionality), and/or other equipment (e.g., routers, load balancing mechanisms, etc.).

A.3. Exemplary Client-End Details (FIG. 3)

FIG. 3 provides additional details regarding the representative client media device 104 (introduced in the context of FIG. 1). Salient features of the system 100 in which the client media device 104 is employed are also repeated in FIG. 3 to provide context.

In the system, the operations center 102 forwards media information to the client media device 104 via the OC-to-local coupling mechanism 110. This routing path defines the communication channel 126. In one case, the operations center 102 routes PIP alerts 122 along with a primary stream of media information over the communication channel 126. The primary stream corresponds to what the consumer happens to watching, typically in full scale mode, as a main focus of interest. Alternatively, or in addition, the operations center 102 can deliver the PIP alerts 122 to output devices 302 that are separate from the client media device 104 on which the primary media information stream is being presented.

Now turning to the client media device 104 itself, this unit comprises the above-identified media processing module 130 coupled to the media presentation module 132. In one case, the media processing module 130 can comprise AV processing functionality integrated with the media presentation module 132 in a single integrated device (e.g., a single IP-ready television set). In another case, the media processing module 130 can comprise a separate set-top box (or other kind of separate unit) that communicatively couples to the media presentation module 132 (e.g., a television screen).

The media processing module 130 can include a number of modules for performing its ascribed tasks. To begin with, the media processing module 130 includes a network interface module 304. The network interface module 304 can represent any functionality for receiving media information from the operations center 102 using any coupling mechanism. For example, the network interface module 304 can comprise an Ethernet NIC, a DSL modem, a cable modem, a wireless network interface, or other kind of network interface equipment.

The media processing module 130 also includes memory 306. A portion of the memory may comprise a FIFO-type buffer for storing media information prior to the information being decoded. The use of a buffer is advantageous to steady the performance of the client media device 104, e.g., by giving the client media device 104 a chance to fill in “holes” caused by missing packets before consuming such media information containing the missing packets.

The media processing module 130 also includes an audio-visual (AV) decoder 308 for decoding (and decompressing) the received media information into its video and audio components. Decoding comprises ordering packets (if received out of order), extracting media information from the stream of received packets, and also extracting timing information that will govern the playback of the media information.

The media processing module 130 also includes one or more processors 310 for executing instructions to implement the functionality of the media processing module 130.

The media processing module 130 also includes an I/O interface for interacting with the consumer via one or more input devices (e.g., a remote controller 314, a PC 316, a joy stick (not shown), a touch screen input mechanism (not shown), and so forth).

The media processing module 130 also includes an A/V interface module 318 for providing media information in an appropriate format (e.g., in an appropriate color space) to the media presentation module 132.

The media processing module also includes the above-identified local store 144 for storing PIP alert information, profile information, logic used to implement the client-side event processing functionality 142, and/or other information. To emphasize once more, one implementation attempts to minimize the complexity of the client media device 104, so the local store 144 may contain minimal event-related information/functionality (and possibility no such information/functionality).

Finally, the client processing module 130 can include various other modules 320, not specifically enumerated in the figure. For instance, the client processing module 130 can include a graphics compositor for combining a video component of the media information from the AV decoder 308 on a frame-by-frame basis with graphics information. The graphics information may comprise various user interface presentations which are overlaid on the media information. Similarly, the client processing module 130 can also include an audio mixer that combines an audio component of the media information received from the AV decoder 308 on a sample-by-sample basis with the supplemental audio information.

The media presentation module 132 may comprise any kind of device for presenting AV information, including a CRT-type device, an LCD-type device, and so forth. In any case, the media presentation device 132 defines a display surface 322. The media processing module 130 can present one or more user interface presentations 324 on the display surface 322. Further, the media processing module 130 can prompt the display of one or more PIP panels on the display surface 324, as will be the primary topic of the next Section.

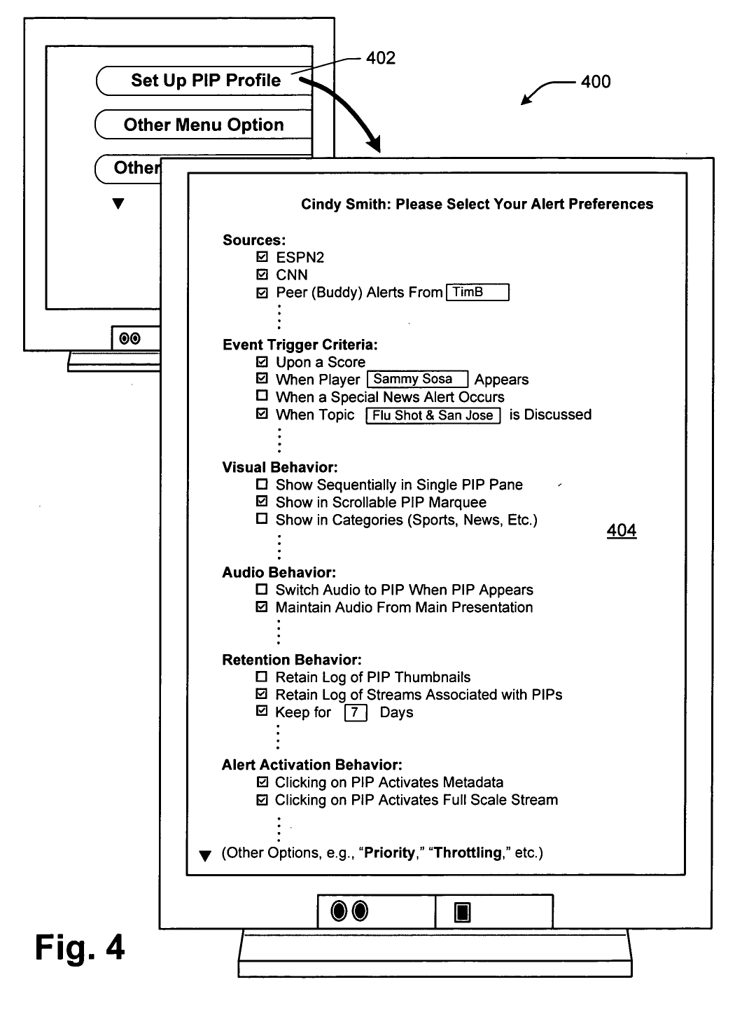

B. Exemplary User Interface Presentations (FIGS. 4-8)

This section sets forth exemplary user interface presentations that the client media device 104 (of FIG. 3) can display on its media presentation module 132. Namely, subsection B.1 describes an exemplary user interface presentation that allows a consumer to create a consumer profile via the client media device 104. Subsection B.2 describes exemplary user interface presentations for displaying PIP alerts 122. The user interface functionality can be implemented by logic stored at the operations center (e.g., by the event notification module 212), by logic stored locally at the client media device 104, or by a combination of logic stored at the operations center 102 and the client media device 104.

B.1. Exemplary Mechanism for Specifying Preferences

FIG. 4 shows one exemplary user interface mechanism 400 by which a consumer (the fictitious “Cindy Smith”) can specify preferences. As described in connection with FIG. 2, the event processing functionality 120 stores the preferences in its consumer preference module 202 as a consumer profile. The event processing functionality 120 then uses this consumer profile to govern various aspects of the event processing functionality when interacting with the consumer, Cindy Smith.

To begin with, the client media device 104 may present a menu having plural options. One option 402 may allow to the consumer to activate a preference sheet 404. The preference sheet 404 allows the consumer to enter various categories of criteria that will govern the operation of event processing functionality 120. The categories identified in the property sheet were previously discussed in Section A, and will be explained again here in the context of the specific example set forth in FIG. 4.

A sources category identifies where the event information originates from. In this specific example, the consumer has indicated that she wishes to cull events from sources associated with the ESPN2 and CNN content providers (which provide sports information and news information, respectively). The consumer has also indicated that she wishes to receive Email and IM messages from a friend having an alias of TimB. The reader will appreciate that the illustrated sample of source criteria shown in FIG. 4 is merely a small number of many sources that can be identified in this category of criteria. Further, the illustrated UI mechanisms used to input source criteria is merely exemplary; for instance, instead of providing a list of possible sources, the property list 404 can allow the consumer to enter a channel number to identify a source from which event information can be extracted.

An event trigger category identifies the rules used to determine when an event becomes a reportable event. In this specific example, the consumer has indicated that she wishes to create an event upon a change in score, when the player name “Sammy Sosa” appears (e.g., as assessed by examining the closed-captioned information provided by the ESPN2 channel), and when the topic “Flu Shot” combined with “San Jose” is discussed (again, which can be determined by examining closed-captioned information). The reader will appreciate that the illustrated sample of trigger criteria is merely a small number of many triggers that can be identified via this criteria category.

A visual behavior category identifies the manner in which the PIP alerts 122 are presented on the display surface 322 of the media presentation module 132. In this specific example, the consumer has indicated that she wishes to present the PIP alerts 122 as a scrollable marquee-type display. Another option permits the client media device 104 to present the alerts 122 in a single-pane sequencing/cycling display. Another option permits the client media device 104 to convey the PIP alerts 122 in such a manner that reveals their category, e.g., by presenting the PIP alerts 122 in separate marquees corresponding to separate categories, by displaying category-related information for each PIP alert 122, and so forth. The reader will appreciate that the illustrated sample of visual behavior criteria is merely a small number of many visual behavior criteria that can be identified via this criteria category. For example, this criteria category can optionally also allow the user to determine where the PIP alerts 122 are to be presented on the screen (for example, as overlays positioned over the primary presentation, as supplemental content within the letterbox area of the display, and so forth).

An audio behavior category identifies the manner in which the event processing functionality 120 presents an audio component of the PIP alerts 122. In this specific example, the consumer has opted to continue presenting the audio associated with a main AV presentation upon the appearance of a PIP alert 122 (as opposed to switching the audio to the PIP pane so that it presents the audio component of the PIP stream). The reader will appreciate that the illustrated sample of audio behavior criteria is merely a small number of many audio behavior criteria that can be identified via this criteria category.

A retention behavior category identifies the manner in which the event processing functionality 120 retains PIP alerts 122 that have been presented. In this specific example, the consumer has opted to retain full AV streams associated with the PIP alerts (if they exist), as opposed to storing abbreviated content (such as just a thumbnail and/or linking information which allows the consumer to access more information regarding the stored PIP alerts from remote sources). Storing the entire AV content associated with a PIP allows the consumer to quickly go back and review a PIP alert 122 that she did not have time to view upon its first occurrence. The property sheet 404 also allows the consumer to define how long PIP alerts 122 are to be retained (here set as 7 days). Although not shown, the consumer can override this retention mechanism to indefinitely archive any PIP alert 122. The reader will appreciate that the illustrated sample of retention behavior criteria is merely a small number of many retention behavior criteria that can be identified via this criteria category.

An activation behavior category identifies the manner in which the PIP alert “behaves” when the consumer activates it. In this specific example, the consumer has made a selection which prompts the event processing functionality 120 to display additional textual metadata when the consumer clicks on the PIP alert 122. The consumer also has made a selection which prompts the event processing functionality 120 to display a full scale AV stream associated with the PIP alert 122 (if it exists) when the consumer clicks on the PIP alert 122. The reader will appreciate that the illustrated sample of activation behavior criteria is merely a small number of many activation behavior criteria that can be identified via this criteria category.

The above-enumerated categories are exemplary. Other categories can be provided, or one or more of the above-identified categories can be omitted from a specific implementation. For instance, although not shown, additional preference criteria can be defined which allow the consumer to rank PIP alerts 122. This provides a valuable mechanism for prominently presenting the most interesting or critical alerts to the consumer. Ranking may have the effect of ordering the PIP alerts 122 in a defined sequence, or entirely omitting low-interest PIP alerts 122 that occur at a time of high alert volume. These kinds of criteria help reduce the risk that the client media device 104 will be inundated with too many PIP alerts 122. Other throttling-type criteria can specify a maximum number of PIP alerts that can be presented per time period, and so forth.

Other mechanisms can be used to supplement the manual specification of preference information. One mechanism can apply fixed rules to provide certain default criteria to all consumers or to a certain class of consumers having prescribed characteristics. Another mechanism can apply a learning engine to automatically assess which topics the consumer is interested in, and adjust the ranking associated with different PIP alerts depending on this empirical data. For example, the event processing functionality 120 can determine the frequency at which a consumer activates PIP alerts 122 in different categories of alerts, indicating that the consumer is interested in some kinds of PIP alerts 122 but not others. This feedback can be used to provide more PIP alerts of a certain popular type, and less PIP alerts of another, more unpopular, type.

Another mechanism can use the PIP alerts as an up-selling or cross-selling opportunity. For instance, even though a consumer has not subscribed to a particular channel, the operations center 102 can generate a PIP alert 122 which provides a video snippet of a program being aired on that channel. This might entice the consumer to take the steps necessary to subscribe to this channel. Other marketing opportunities can be used to provide PIP alerts based on the consumer's purchase or consumption of similar media products or complementary media products. This could be used to entice a consumer away from one pay channel to another pay channel, and so forth.

B.2. Exemplary Mechanisms for Presenting Alerts

This subsection discusses different exemplary ways that the PIP alerts 122 can be presented on the display surface 322 of the media presentation module 132 of the client media device 104.

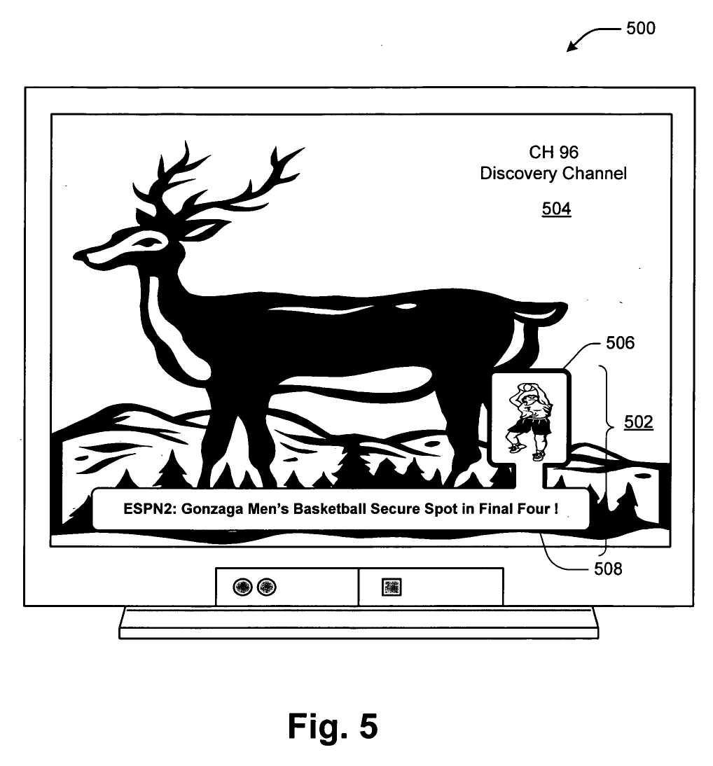

FIG. 5 shows a first scenario 500 in which a PIP alert 502 is presented on the media presentation module 132 so that it “overlays” a main presentation 504. In this case, the main presentation 504 corresponds to a nature show that a consumer happens to be watching when the PIP alert 502 appears. The PIP alert 502 alerts the consumer to the fact that an interesting event is occurring on another channel, namely ESPN2. (The examples set forth in this section show the PIP alerts 122 presented as overlays which obscure a primary presentation; however, once again, these PIP alerts 122 can be displayed in other areas, such as the unused portion of a letterbox area of the screen.)

The PIP alert 502 itself can adopt any size, shape, on-screen position, behavioral characteristics, style, etc. In the exemplary case shown in FIG. 5, the PIP alert 502 includes a rectangular PIP pane 506 that presents a static image (e.g., a key frame thumbnail) pertaining to the event, or a live video stream associated with the event, or some other content. In the event that the PIP pane 506 captures only a static thumbnail, that thumbnail is preferably selected so as to coincide with whatever occurrence has been deemed noteworthy (such as the shooting of a three point shot at a critical juncture in a basketball game, and so on). The PIP alert 502 can also optionally include a text portion 508 associated therewith, which provides textual information which describes the event. This information is useful, as the video image (or static image) may fail to convey the true nature of the event to the consumer.

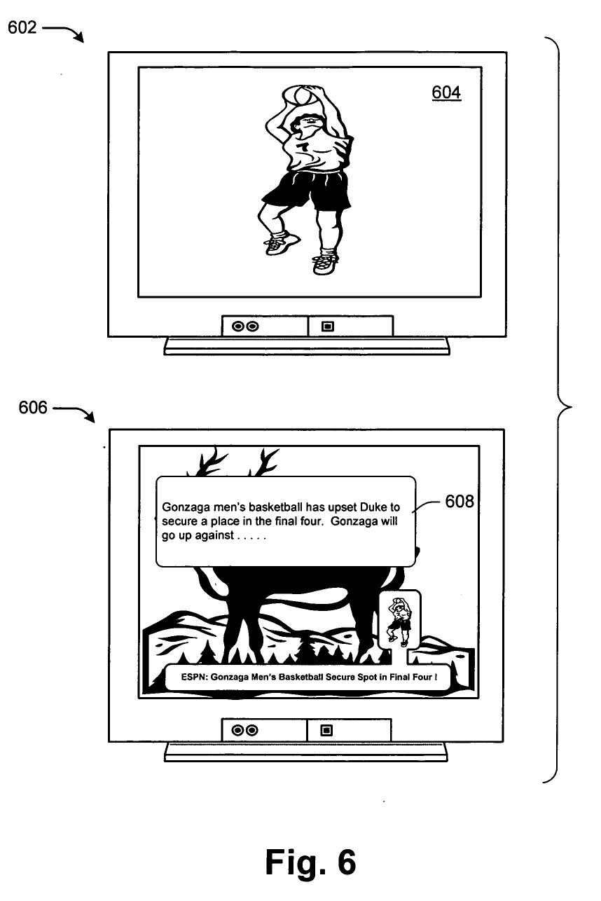

FIG. 6 shows different kinds of behavior which can be invoked when the consumer selects the PIP alert 502, e.g., by activating the PIP alert 502 via an input device of any kind. In a first scenario 602, activating the PIP alert 502 prompts the event processing functionality 120 to replace the main presentation 504 associated with the nature program with another main presentation 604 corresponding to the selected PIP alert 502. This can be implemented by switching from a reduced resolution PIP stream (used to feed the PIP pane 506) to a full scale resolution PIP stream, and projecting that full scale resolution PIP stream over the entire display surface 322 of the media presentation module 132. A “go back” control (e.g., provided on the remote controller) or on the screen itself (not shown) can allow the consumer to go back to the main presentation 504 that she was previously watching.

In a second scenario 606, activating the PIP alert 502 prompts the event processing functionality 120 to provide additional text metadata 608 associated with the PIP alert 502. The consumer might then be given the option of advancing to the full scale stream presentation associated with the PIP alert 502 (if it exists).

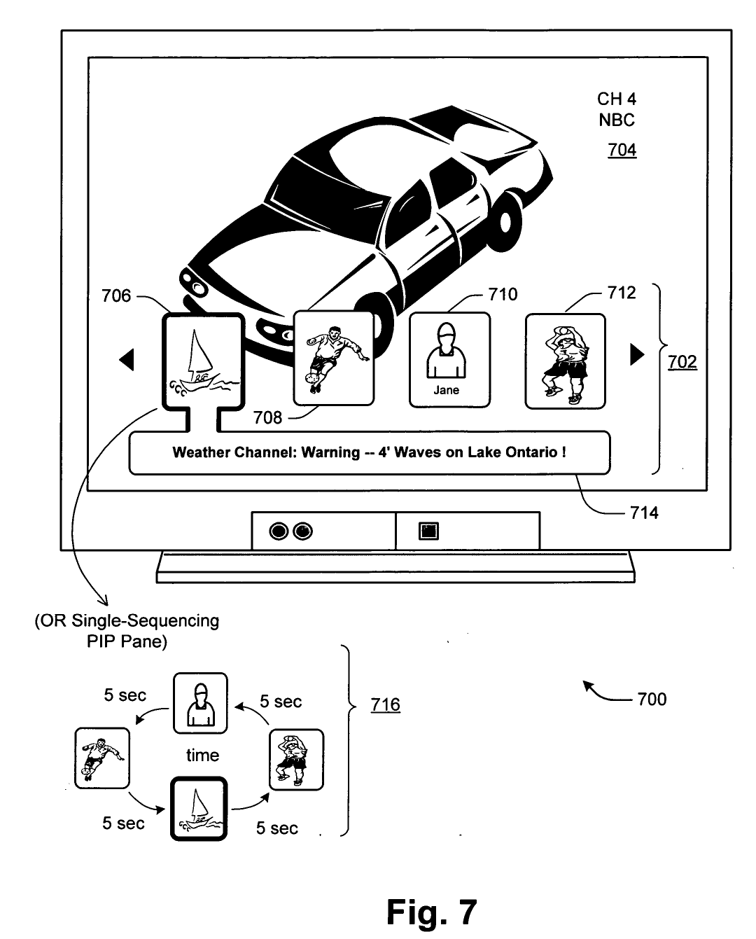

FIG. 7 shows a scenario 700 in which the event processing functionality 120 presents plural PIP alerts 702. Again, the consumer is watching a main presentation 704 at the time when the PIP alerts 702 occur. The PIP alerts 702 are represented by an exemplary array of four PIP panes (706, 708, 710, and 712), corresponding to different respective events. For example, PIP pane 706 may correspond to a weather advisory. The user has selected this PIP pane 706 using an input device, as indicated by the highlighted border associated with the PIP pane 706. Because this PIP pane 706 is selected, its attached text bubble 714 presents a textual description of the alert associated with the PIP pane 706. PIP panes 708 and 712 correspond to events which have occurred or are occurring in respective televised sporting events. PIP pane 710 corresponds to a message transmitted to the consumer by a fellow-consumer, Jane, via Email or IM. The picture displayed in the PIP pane 710 is that of Jane; or the PIP pane 710 may present other predefined static or dynamic content associated with Jane. Once again, the size, shape, on-screen position, style, etc. of the PIP alert 702 is exemplary and non-limiting.

Moreover, in one implementation, the event processing functionality 120 can provide a navigation mechanism that allows the consumer to scroll to the left or to the right to retrieve additional PIP alerts. The PIP alerts can be arranged in chronological order based on time of event detection or time of event occurrence (if this is different than time of event detection). The PIP alerts can, in addition, or alternatively, be arranged according to any kind of ranking scheme, e.g., based on assessed importance as reflected by priority criteria set forth in the consumer's profile.

Additional information can be conveyed by the PIP alerts 702. For example, each PIP alert pane can include indicia (e.g., symbolic information, color tinting, etc.) which convey the category of the associated PIP alert. For example, the event processing functionality 120 can display all sports-related PIP alerts in a rose-colored background (or with a rose-colored PIP pane border), all news-related PIP alerts in a yellow-colored background color (or with a yellow-colored PIP pane border), and so forth. Alternatively, the event processing functionality 120 can devote separate arrays of PIP alerts for different categories of events, or can convey different categories of PIP alerts using different shaped PIP panes, etc.

Finally, FIG. 7 illustrates that, instead of laying out the plural PIP alerts in an array, the event processing functionality 120 can display the plural PIP alerts in a single PIP pane. The single PIP pane can sequence through the PIP alerts, devoting a predetermined amount of time to each PIP alert before advancing to the next. Or the consumer can manually control this sequencing operation by advancing through the PIP alerts on command. The cyclical sequencing illustration 716 represents this concept.

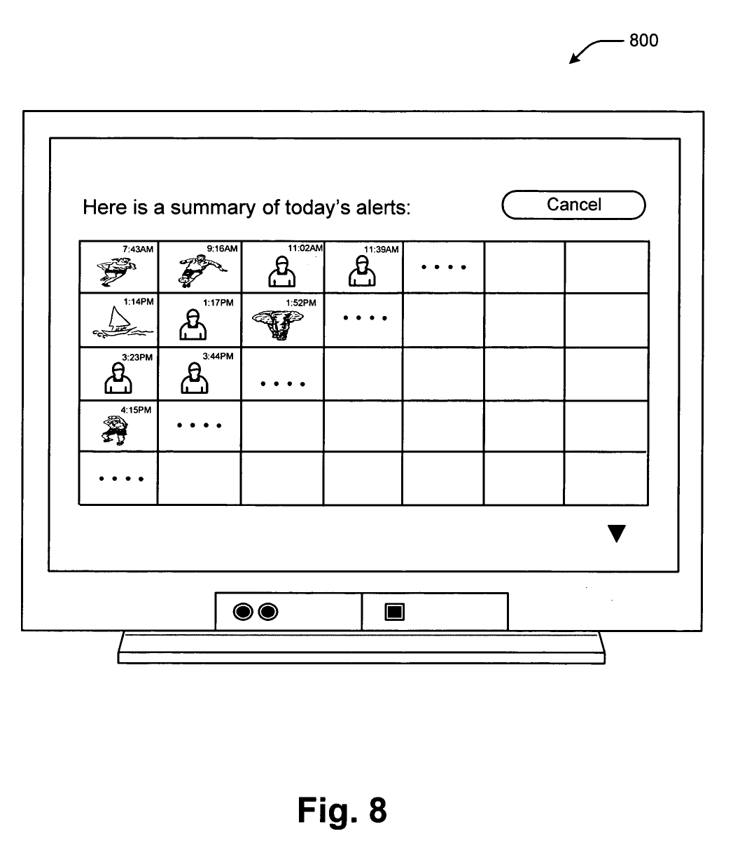

FIG. 8 shows another display scenario 800. This scenario 800 illustrates a way of presenting PIP alerts that have occurred over a predetermined amount of time, such as a day or a week. This mechanism provides an interface through which the consumer can activate PIP alerts that she did not have a chance to view upon their initial occurrence. Clicking on any selected PIP alert will prompt the event processing functionality 120 to present a video stream corresponding to that alert (if one exists), and/or to provide additional textual metadata associated with that alert, and so forth.

C. Exemplary Method of Operation

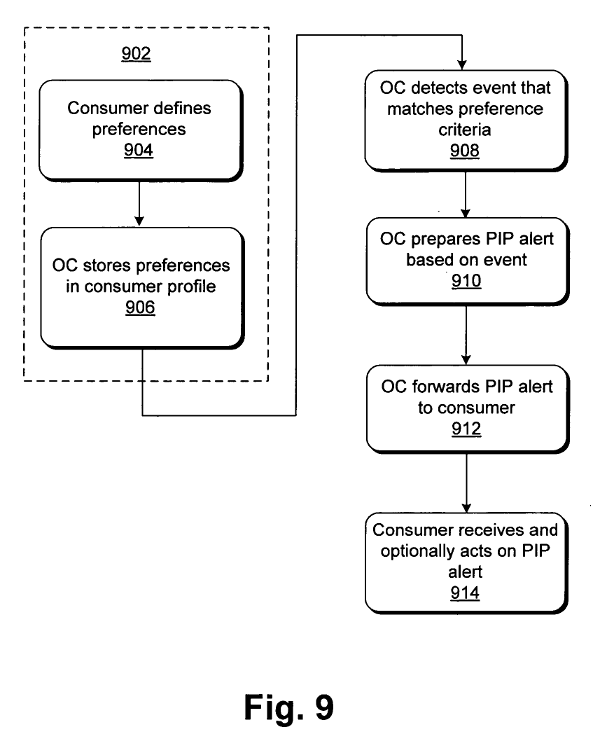

FIG. 9 describes the operation of the event processing functionality 120 in flowchart form. To facilitate discussion, certain operations are described as constituting distinct steps performed in a certain order. Such implementations are exemplary and non-limiting. Certain steps described herein can be grouped together and performed in a single operation, and certain steps can be performed in an order that differs from the order employed in the example set forth in this disclosure. As the functions described in this flowchart have already been explained in prior sections, Section C will serve primarily as a review of those functions.

Phase 902 of the procedure corresponds to the establishment of consumer preferences. In step 904, the consumer accesses the property sheet 404 (discussed in connection with FIG. 4) to define various criteria in different categories. The criteria will govern the operation of the event processing functionality 120. In step 906, the event processing functionality 120 stores the defined preference criteria as a profile within the profile store 206.

In a consumption phase of procedure, in step 908; the operations center 102 detects an event that satisfies the preference information set forth in the consumer's profile. In step 910, the operations center 102 formulates the detected reportable event into a PIP alert based on preference information specified in the consumer's profile. In step 912, the operations center 102 forwards the PIP alert 122 to the consumer's client media device 104, where it is displayed (e.g., in a PIP pane that is overlaid on a main presentation, as described in the previous section). In step 914, the consumer reviews the PIP alert 122 and optionally acts on it, causing the kinds of actions described above in the previous section, such as the presentation of a full-scale stream corresponding to the selected PIP alert 122, the presentation of additional textual metadata associated with the PIP alert 122, and so forth.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for presenting alerts to a consumer of media information, comprising:
detecting an event from at least one source of events that meets at least one pre-established criterion defined by the consumer, to define a matching event;
in response to the detecting, automatically formulating the matching event into a picture-in-picture (PIP) alert having a pictorial component; and
providing the PIP alert to an output device associated with the consumer, where the PIP alert is automatically presented by the output device.

2. The method of claim 1, wherein the detecting comprises accessing a profile associated with the consumer to provide said at least one criterion.

3. The method of claim 2, wherein said profile sets forth one or more of:
at least one potential source of events;
at least one trigger criterion that defines when an event is assessed as a matching event;
at least one visual behavior criterion that defines a manner in which a visual component of the PIP alert is presented on the output device;
at least one audio behavior criterion that defines a manner in which an audio component of the PIP alert is presented on the output device;
at least one retention behavior criterion that defines a manner in which the PIP alert is retained for later access by the consumer; and
at least one activation behavior criterion that defines a manner in which the PIP alert behaves when the consumer activates the PIP alert.

4. The method of claim 1, wherein the formulated PIP alert comprises a thumbnail picture associated with the matching event.

5. The method of claim 1, wherein the formulated PIP alert comprises a video stream associated with the matching event.

6. The method of claim 1, wherein the formulated PIP alert comprises descriptive textual material in addition to its pictorial component.

7. The method of claim 1, wherein the output device is a client media device, and wherein the client media device presents the PIP alert on the client media device as an overlay on top of a primary presentation of media information.

8. The method of claim 1, wherein the output device is a supplemental device apart from a client media device used to provide a primary presentation of media information.

9. The method of claim 1, wherein the detecting, formulating and providing provide plural PIP alerts corresponding to plural respective matching events, and wherein the output device presents the plural PIP alerts, and allows the consumer to select among the plural PIP alerts.

10. The method of claim 9, wherein the output device presents multiple PIP alerts at the same time.

11. The method of claim 9, wherein the output device sequences through multiple PIP alerts within a single PIP alert pane.

12. The method of claim 9, further comprising, navigating among the plural PIP alerts to select a desired PIP alert in response to the consumer's input.

13. The method of claim 1, wherein activation of the PIP alert prompts the output device to perform one or more of:
providing supplemental textual descriptive matter pertaining to the PIP alert; and
providing supplemental pictorial matter pertaining to the PIP alert.

14. One or more machine-readable media containing machine-readable instructions for implementing the method of claim 1.

15. Event processing functionality for presenting alerts to a consumer of media information, comprising:
logic configured to detect an event from at least one source of events that meets at least one pre-established criterion defined by the consumer, to define a matching event;
logic configured to automatically formulate, in response to the event detection, the matching event into a picture-in-picture (PIP) alert having a pictorial component; and
logic configured to provide the PIP alert to an output device associated with the consumer, where the PIP alert is automatically presented by the output device.

16. One or more machine-readable media containing machine-readable instructions for implementing the event processing functionality of claim 15.

17. A method for presenting alerts to a consumer of media information, comprising:
receiving plural PIP alerts associated with respective detected events at an output device associated with the consumer;
presenting the plural PIP alerts using the output device;
navigating among the plural PIP alerts to select a desired PIP alert in response to the consumer's input;
selecting the desired PIP alert in response to the consumer's input; and
executing predefined presentation behavior in response to the consumer's selection of the desired PIP alert.

18. The method of claim 1, wherein the PIP alert has a pictorial component associated therewith.

19. The method of claim 1, wherein the presenting of the plural PIP alerts comprises one or more of:
presenting multiple PIP alerts at the same time; and
presenting a single PIP alert pane which sequences through multiple PIP alerts.

20. One or more machine-readable media containing machine-readable instructions for implementing the method of claim 18.
